(19) United States
(12) Patent Application Publication
(10) Pub. No.: US 2004/0177474 A1
(43) Pub. Date: Sep. 16, 2004

(54) Direction stabilizer device

(76) Inventor: Michael Colin John Swanborough, High Wycombe (GB)

Correspondence Address: LAHIVE & COCKFIELD, LLP., 28 STATE STREET, BOSTON, MA, 02109, US

(21) Appl. No.: 10/486,139

(22) PCT Filed: Aug. 6, 2002
(86) PCT No.: PCT/GB02/03621

(30) Foreign Application Priority Data
Aug. 6, 2001 (GB) 0119151.9

(51) Int. Cl. B60B 33/00

(52) U.S. Cl. 16/35 R

(57) ABSTRACT

A direction stabilizer device for a castor type wheel (1) which is arranged to swivel about a swivel axis, the direction stabilizer device comprising a centrifugal means arranged to operate a locking mechanism to lock the wheel in a pre-set orientation about the swivel axis, when the wheel (1) is rotated. The direction stabilizer device is arranged such that the locking mechanism operates to lock the wheel in the pre-set orientation only when the wheel (1) is rotated above a pre-defined speed. The direction stabilizer device is also arranged such that the rotation of the wheel (1) causes the centrifugal means to rotate, such rotation operating the locking mechanism.

### TECHNICAL FIELD

This invention relates to a direction stabilizer device used in conjunction with any castor type wheel, for example on a baby's buggy or hospital bed. It is particularly suitable for use on trolleys and most suitable for use on supermarket trolleys.

### BACKGROUND PRIOR ART

It is well known that trolleys which have castor type wheels, and supermarket trolleys in particular, tend to resist the directional steering of the person using the trolley. A castor type wheel is defined as one which has a swivel mounting such that when fitted to a fixed member, for example, a table leg or trolley leg, the wheel is able to swivel in a clockwise or anticlockwise direction about a swivel axis. Such castor type wheels enable the trolley to be moved in any direction the shopper wishes as he or she makes their way up and down and around the ends of the aisles of the supermarket. This freedom of motion is desirable when the trolley is being manoeuvred around the ends of aisles but becomes problematic as the shopper traverses the straight long lengths of an aisle.

United Kingdom Patent Application GB2361179 discloses a castor arrangement, in which, when fitted to a supermarket trolley and the trolley is empty, a locking element is maintained out of engagement with a co-operating locking formation, enabling the castor wheel to swivel. However, when the trolley contains a predetermined load, the locking element moves into engagement with the co-operating locking formation, thereby preventing the castor wheel from swivelling. A problem with such an arrangement is that it requires a certain quantity of shopping to have been carried out such that it provides a predetermined minimum load in the trolley before the locking mechanism engages. Another problem is that once locked the trolley loses its ability to be manoeuvred around the aisles and in any other direction but forward or backward in a line parallel with the trolley. This can cause a problem when the shopper wishes to continue to shop for more than the predetermined load the trolley requires to lock the mechanism.

The present invention therefore seeks to provide a practicable solution to the above problems.

### SUMMARY OF THE INVENTION

According to a first aspect of the invention there is provided a direction stabilizer device for a castor type wheel which is arranged to swivel about a swivel axis, the direction stabilizer device comprising a centrifugal means arranged to operate a locking mechanism to lock the wheel in a pre-set orientation about the swivel axis when the wheel is rotated.

A second aspect of the invention provides a castor type wheel having a direction stabilizer device according to the first aspect of the invention attached thereto.

A third aspect of the invention provides a movable apparatus including at least one castor type wheel according to the second aspect of the invention. Preferably the apparatus is a trolley, especially a supermarket trolley, but it may alternatively be a baby's buggy, a hospital bed, or the like. The apparatus may generally be any apparatus arranged to be moved manually and having castor type wheels, which may benefit from a direction stabilizer.

Other preferred and optional features of the invention are described below and in the dependent claims.

### BRIEF DESCRIPTION OF THE. DRAWINGS

Embodiments of the invention will now be further described, by way of example, with reference to the accompanying drawings, in which:

FIG. 1 is a side view of the device as fitted to a castor type wheel;

FIG. 2 is a front view of the device and wheel shown in FIG. 1;

FIG. 3 is a plan view of the device and wheel shown in FIG. 1;

FIG. 4 is a side view of the wheel and device when the wheel is locked in a pre-set orientation;

FIG. 5 is a side view of the wheel and device when not locked in a pre-set orientation; and

FIG. 6 is a perspective view of part of the device.

### DETAILED DESCRIPTION OF THE INVENTION

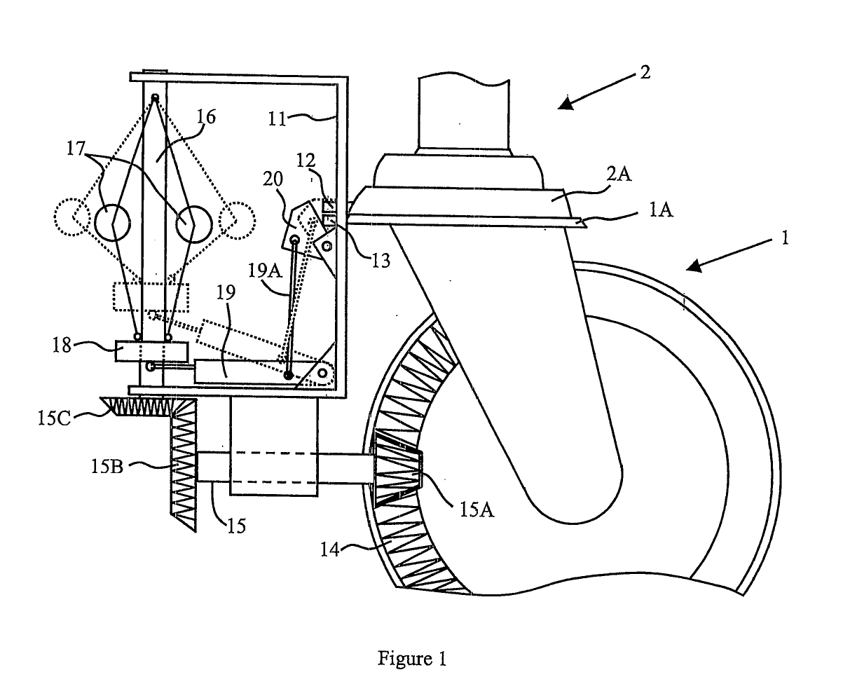

FIG. 1 shows a metal frame 11, housing the direction stabilizer device. The metal frame is shown here as a bracket type arrangement, but the entire locking mechanism may be housed in a closed metal frame, which may be preferable when the device is fitted to a trolley.

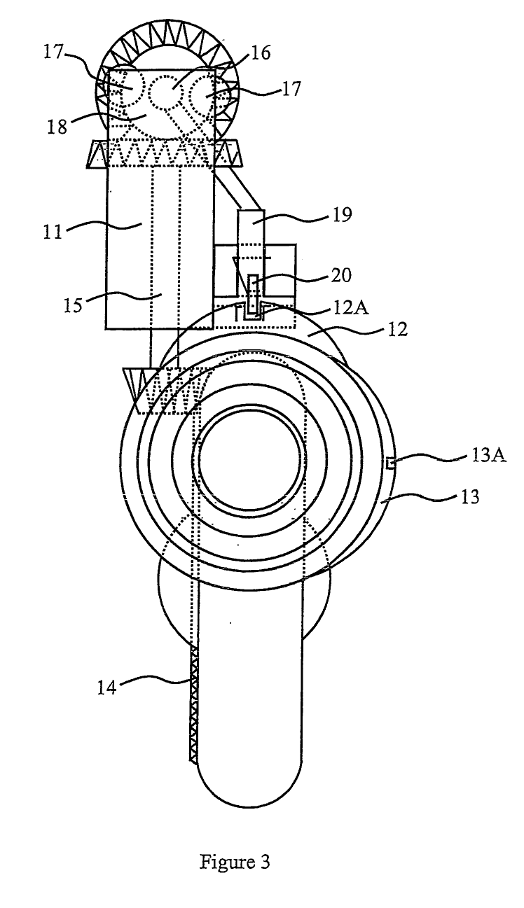

The metal frame 11 is fitted onto a swivelling portion 1A of the castor wheel 1, by means of a locking lip 13. A similar lip 12 is fitted to a static part 2A of the trolley leg 2. Both lips 12, 13 include slots (see FIG. 3) with which a locking arm 20 may interlock to prevent mutual rotation of the lips, as described below. FIG. 1 also shows a toothed ring gear 14 which is fixed to a side of the castor wheel 1, and which drives toothed cogs 15A of a drive shaft 15, when the wheel 1 of the trolley moves in a forward direction. Cogs 15B of the drive shaft 15 drives a cog wheel 15C, which rotates a vertical spindle 16, thus activating the centrifugal means. The centrifugal means comprises rotatable weights 17, which are connected to a lifting bearing 18. As the castor wheel rotates faster, the centrifugal means rotates faster, and the weights 17 describe a circle of increasing radius and thus raise the lifting bearing 18 higher up the spindle 16. This motion is shown in dashed lines, as is the resulting position of the lifting arm 19. The lifting arm 19 is connected via a push rod 19A to the locking arm 20.

When the speed of rotation of the castor wheel 1 reaches a pre-defined speed (which, for example, for supermarket trolleys, equates to a trolley speed of about four miles per hour, i.e. walking pace), the outward displacement of the weights 17 is such that the lifting bearing 18 has lifted the locking arm 20 into contact with locking lips 12 and 13. Consequently, when the wheel is in its pre-set orientation (preferably directly forwards) at this speed, the slots in the lips 12 and 13 are in alignment with each other and the locking arm interlocks with both of them, locking the wheel in its pre-set orientation.

When the speed of the castor wheel 1 is reduced below its pre-defined speed, the displacement of the weights 17 reduces, the lifting bearing 18 moves down the spindle 16 and consequently the locking arm 20 disengages from the locking lips 12 and 13, allowing the castor wheel to swivel once more.

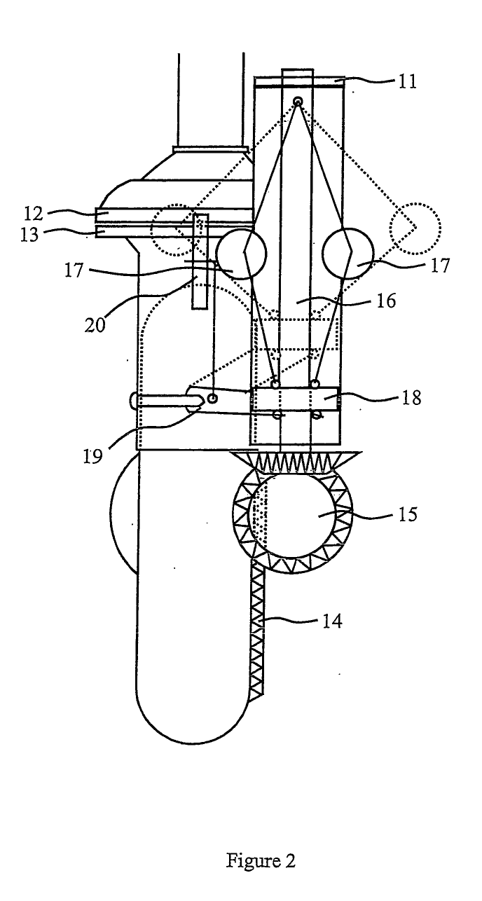

FIG. 2 shows the locking arm 20 from a front view, being raised when the centrifugal means is in operation, such as to slot into position to prevent the locking lips 12 and 13 rotating with respect to each other.

FIG. 3 shows clearly the slot 13A on locking lip 13, which when it coincides with the slot 12A of locking lip 12, as the wheel is driven in a forward direction, allows the locking arm 20 to slot into position.

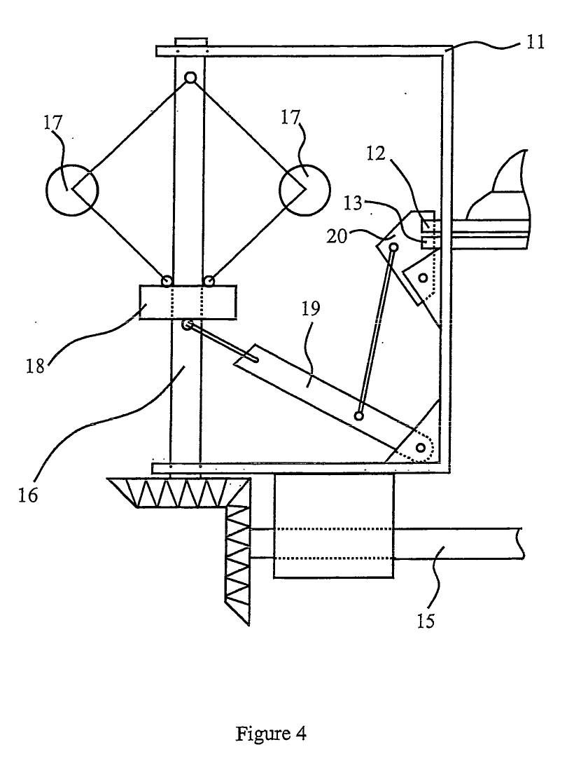

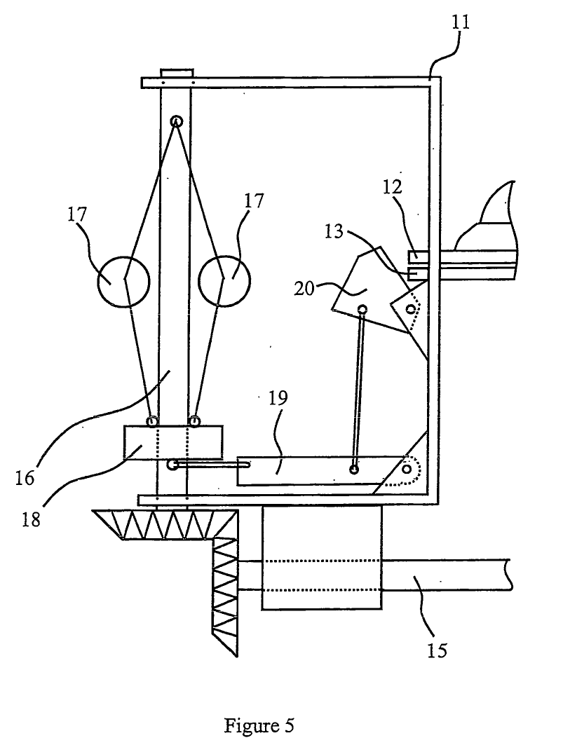

FIG. 4 shows the position of each component when the locking mechanism is in operation. FIG. 5 shows the position of each component when the locking mechanism is not in operation.

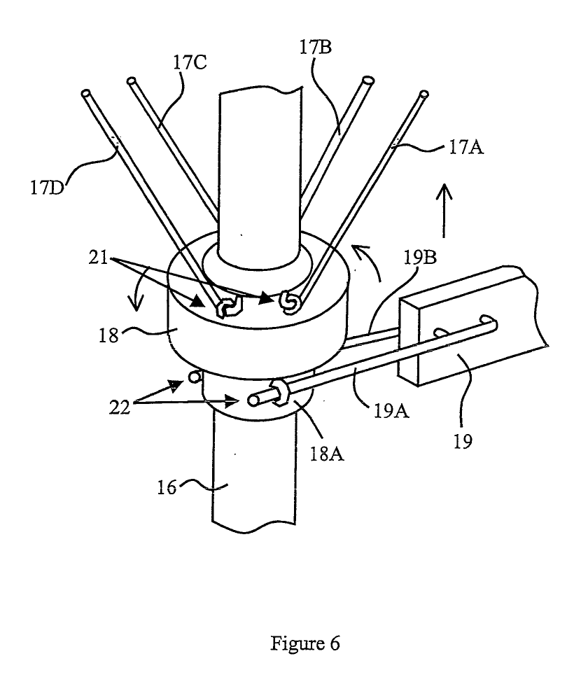

FIG. 6 shows the connecting rods 17A, 17B, 17C and 17D of the hung weights 17, connected to the lifting bearing 18 by means of attachments 21. Connecting rods 19A, 19B of the lifting arm 19, are connected to a non-rotating part 18A of the lifting bearing 18 by means of attachments 22. As the lifting bearing 18 rotates in an anticlockwise or clockwise direction, it is lifted as a result of the centrifugal force acting on the weights 17. This upward motion has the effect of raising lifting arm 19 via the connecting rods 19A, 19B.

Although in the example above, the lifting bearing 18 is arranged to move in an upward motion when the centrifugal means is in operation, and the locking arm 20 also moves in an upward direction to lock the lips 12 and 13, it will be understood by the skilled person, that the lifting bearing 18 may alternatively be arranged such that when the centrifugal means is in operation, the bearing 18 moves in a downward direction, the locking arm 20 will then move in a downward direction to lock the lips 12 and 13. However, in such an alternative embodiment the bearing 18 would need to be spring loaded such that it is raised to the top of the spindle when the castor wheel (and hence the centrifugal means) ceases rotating.

It will also be understood that the operation of the locking mechanism as described above operates when the trolley is pushed in the forward direction relative to the person pushing the trolley. Other embodiments of the invention are possible, in which the static lip 12 includes two slots 12A situated on opposite sides of the trolley leg, so that the orientation of the wheel may be locked in place both when the trolley is pushed in the forwards direction and when the trolley is pulled in the backwards direction.

The embodiment of the invention illustrated and described herein has its centrifugal means and gear mechanism exposed. However, the invention encompasses embodiments in which the centrifugal means and/or the gear mechanism (but preferably the entire device) is/are enclosed. Advantageously, the device (or a part thereof) may be enclosed within the castor wheel itself. (In such embodiments the castor wheel preferably comprises a pair of wheels which together form an enclosed hollow wheel.) In these embodiments the gear mechanism operates by contact with the hollow interior of the wheel (in order to transmit torque from the wheel to the centrifugal means). Enclosing the device within the castor wheel results in a particularly compact, protected and elegant design.

The direction stabilizer device may be fitted to one or more of the wheels of the trolley or other apparatus, depending on the type of apparatus to which the device is fitted.

1. A direction stabilizer device for a castor type wheel (1) which is arranged to swivel about a swivel axis, the direction stabilizer device comprising a centrifugal means arranged to operate a locking mechanism to lock the wheel (1) in a pre-set orientation about the swivel axis, when the wheel is rotated.

2. A direction stabilizer device according to claim 1, wherein the locking mechanism operates to lock the wheel (1) in the pre-set orientation only when the wheel (1) is rotated above a pre-defined speed.

3. A direction stabilizer device according to claim 1 or claim 2, wherein rotation of the wheel (1) causes the centrifugal means to rotate, such rotation operating the locking mechanism.

4. A direction stabilizer device according to claim 3, wherein the centrifugal means comprises at least one pair of weights (17), situated on opposite sides of a rotational axis, rotation of the centrifugal means comprising rotation of the weights (17) about the rotational axis.

5. A direction stabilizer device according to claim 4, wherein the operation of the locking mechanism is caused by an outward displacement of the weights (17) due to the rotation of the centrifugal means.

6. A direction stabilizer device according to claim 5, wherein the weights (17) are connected to a bearing (18) carried on a spindle (16) coaxial with the rotational axis of the weights (17), wherein the bearing (18) is moved along the spindle (16) by the displacement of the weights (17).

7. A direction stabilizer device according to claim 6 wherein the locking mechanism is operated by the movement of the bearing (18).

8. A direction stabilizer device according to any preceding claim, further comprising a first member (13) arranged to swivel with the wheel (1) and a second member (12) that is fixed with respect to the swivel axis, the locking mechanism including a locking arm (20) arranged to engage with both the first and the second members (12, 13) to prevent their relative rotation when the locking mechanism operates and the wheel (1) is in its pre-set orientation.

9. A direction stabilizer device according to claim 3 or any claim dependent thereon, further comprising a gear wheel mechanism arranged to transmit torque from the rotating castor wheel (1) to the centrifugal means, thereby to cause the centrifugal means to rotate.

10. A direction stabilizer device according to claim 9, wherein the gear wheels include mutually engaging cogs.

11. A direction stabilizer device according to claim 10, wherein the castor wheel (1) includes cogs by which it transmits torque to the gear wheels.

12. A castor type wheel (1) having a direction stabilizer device according to any preceding claim attached thereto.

13. A movable apparatus including at least one castor type wheel (1) according to claim 12.

14. An apparatus according to claim 13 comprising a trolley, preferably a supermarket trolley.

15. An apparatus according to claim 13 or claim 14, wherein the pre-set orientation of the castor type wheel (1) is such that the directional stabilizer device prevents movement of the apparatus other than directly forwards or backwards when the locking mechanism is in operation.
